(19) United States
(12) Patent Application Publication
(10) Pub. No.: US 2014/0198111 A1
(43) Pub. Date: Jul. 17, 2014

(54) METHOD AND SYSTEM FOR PRESERVING A GRAPHICS FILE

(71) Applicant: International Business Machines Corporation, Armonk, NY (US)

(72) Inventor: Graham J. Wills, Naperville, IL (US)

(73) Assignee: International Business Machines Corporation, Armonk, NY (US)

(21) Appl. No.: 14/078,717

(22) Filed: Nov. 13, 2013

Related U.S. Application Data
(63) Continuation of application No. 13/742,597, filed on Jan. 16, 2013.

(51) Int. Cl. G06T 5/00

(52) U.S. Cl. CPC G06T 5/001
USPC 345/522

(57) ABSTRACT

A method and system for preserving a graphics file that includes at least one graphics object comprises: embedding in the graphics file, by a first application executing on a processor, a semantic representation of the at least one graphics object that is sufficient to re-create and edit the graphic object; and reading the graphics file, by a second application, and extracting the semantic representation and using the semantic representation to re-create the graphics object for display on a display device.

### CROSS-REFERENCE TO RELATED APPLICATIONS

This application is a Continuation of patent application Ser. No. 13/742,597, filed Jan. 16, 2013, assigned to the assignee of the present application, and incorporated herein by reference.

### BACKGROUND

Many editing tool programs are available to generate and save graphics files that include one or more graphic objects, such as a chart, a diagram, or other types of visual representation of information. A typical workflow for conventional editing tools to generate graphics file typically starts by the editing tool reading some type of data or information (step 1), and creating a graphical object or other visual representation of that data or information (step 2). The editing tool saves an internal state of the graphical object in a custom format that can we be used by the editing tool, or a tool in the same family (step 3). The editing tool may also export the graphical object in a standard format (e.g., a PDF) that can be used with tools or applications outside the family (step 4).

Graphical objects exported in such a standard format may typically be used as part of an assembled reporting or a general purpose system. This is adequate, but has one major drawback: there is no well-defined relationship between the internal state of the process used to create the graphics object saved in step 3 and the graphical object represented in the standard format created in step 4. In particular, a user who has received the graphical object in the standard format cannot edit the graphical object or validate that the graphical object represents what it is supposed to without retrieving internal state saved in step 3 from the original creator.

As an example, assume that a web designer and her client uses a graphical tool to read external data and create 100 charts for a web report. The web designer saves original versions of the graphics files and exports the charts to another format, such as a Scalable Vector Graphics (SVG) file. A SVG is an open standard to provide a versatile, vector format for the web and otherwise. Assume further that years later the client request a new web designer to change the colors and the corporate logo in the web report. The new web designers is faced with the task of matching each web file to the original saved versions and updating the original versions with the new colors and logo, which is an error prone and tedious task. If the client had, in the meantime, edited, renamed, or moved the original graphics files, this task might be impossible and the new web designer might be forced to re-create the charts from scratch.

Accordingly, it would be desirable to provide an improved method and system for preserving a graphics file.

### BRIEF SUMMARY

The exemplary embodiment provides methods and systems for preserving a graphics file that includes at least one graphic object. Aspects of exemplary embodiment include embedding in the graphics file, by a first application executing on a processor, a semantic representation of the at least one graphics object that is sufficient to re-create and edit the graphic object; and reading the graphics file, by a second application, and extracting the semantic representation and using the semantic representation to re-create the graphics object for display on a display device.

According to the method and system disclosed herein, the exemplary embodiment allows a user to use the graphics file with any tool that supports the standard format of the graphics file, while retaining an embedded semantic representation that contains sufficient information to verify, modify and re-create the graphical object as a second way of using the graphics file without accessing additional resources.

### BRIEF DESCRIPTION OF SEVERAL VIEWS OF THE DRAWINGS

FIG. 1 is a diagram illustrating one embodiment of a system for preserving a graphics file.

FIG. 2 is a flow diagram illustrating one embodiment of a process for preserving a graphics file.

FIG. 3 is a diagram illustrating an example semantic language for a chart definition.

FIG. 4 is a diagram of the chart that is generated from the semantic language chart definition.

### DETAILED DESCRIPTION

The exemplary embodiment relates to methods and systems for preserving a graphics file. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

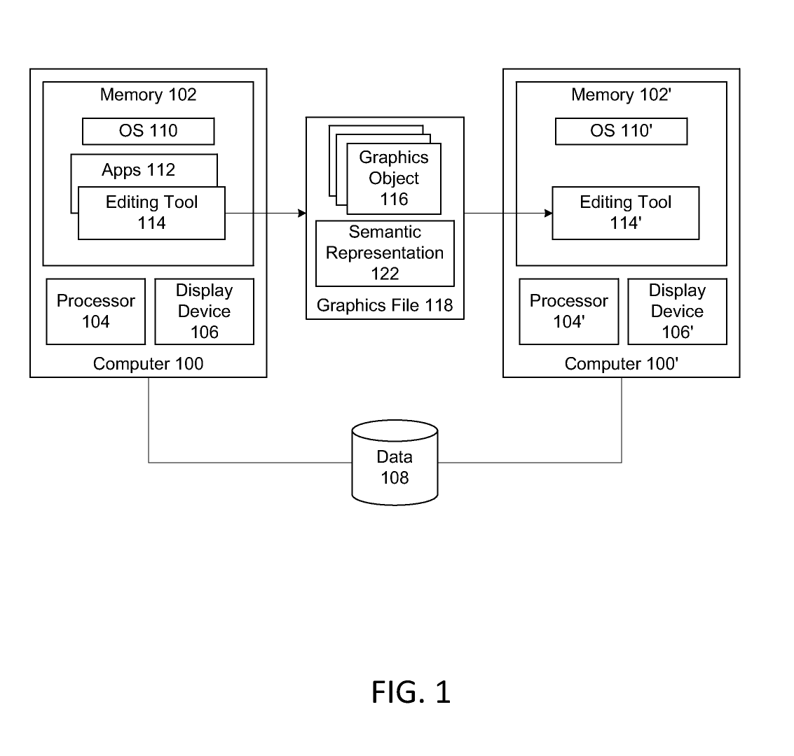

FIG. 1 is a diagram illustrating one embodiment of a system for preserving a graphics file. The system may include one or more computers 100 and 100′, each of which may include a memory 102 and 102′, at least one processor 104 and 104′, and a display device 106 and 106′. Software on the computer 100 may include an operating system (OS) 110, and one or more applications 112, including an editing tool 114. In one embodiment, the OS 110 manages the overall operation of the electronic device 12, including managing the applications 112. The editing tool 114 may optionally access local and/or remote data 108 to create at least one visual representation of the data 108, referred to herein as a graphics object 116, which may displayed on the display device 106. Example types of graphics object 116 may include, but are not limited to, charts, diagrams, graph layouts, maps, architectural and engineering blueprints.

In one embodiment, the editing tool 114 saves an internal state of the graphical object 116 in a custom format that is compatible with other editing tools in the same family as the editing tool 114. According to the exemplary embodiment, the editing tool 114 may also save the graphical object 116 in a standard format that is compatible with an editing tool 114′ not is the same family as the editing tool 114, and in a manner that preserves the internal state of the custom format. This allows the editing tool 114′ on computer 100′ to re-create the graphical object 116 without need for the original custom version of the graphics file 118.

In one embodiment, in addition to saving the graphical object 116 in the graphics file 118, the editing tool 114 preserves the internal state of the graphics object 116 by saving in the graphics file 118 a text-based representation of the graphics object 114, referred to as a semantic representation 122, which enables the other editing tool 114′ to re-create the graphics object 116. In one embodiment, the editing tool 114′ may be in the same or a different family as the editing tool 114, and computer 100′ represent the same or a different computer as computer 100.

Although editing tools 114 and 114′ are shown as single software components, the functionality of the editing tools 114 and 114′ may be implemented using a greater number of modules/components.

The computers 100 and 100′ may be implemented as any device having memory and a processor capable of executing applications, including, but not limited to, a personal computer (PC), a laptop, or a notebook, an ultra book, a tablet, a workstation, and a server. The computers 100 and 100′ and may include hardware components of typical computing devices (not shown), including at least one processor, input devices (e.g., keyboard, pointing device, microphone for voice commands, buttons, touch screen, etc.), and output devices (e.g., a display device, speakers, and the like). The computers 100 and 100′ may include computer-readable media, e.g., memory and storage devices (e.g., flash memory, hard drive, optical disk drive, magnetic disk drive, and the like) containing computer instructions that implement the functionality disclosed when executed by the processor. The computers 100 and 100′ may further include wired or wireless network communication interfaces for communication.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

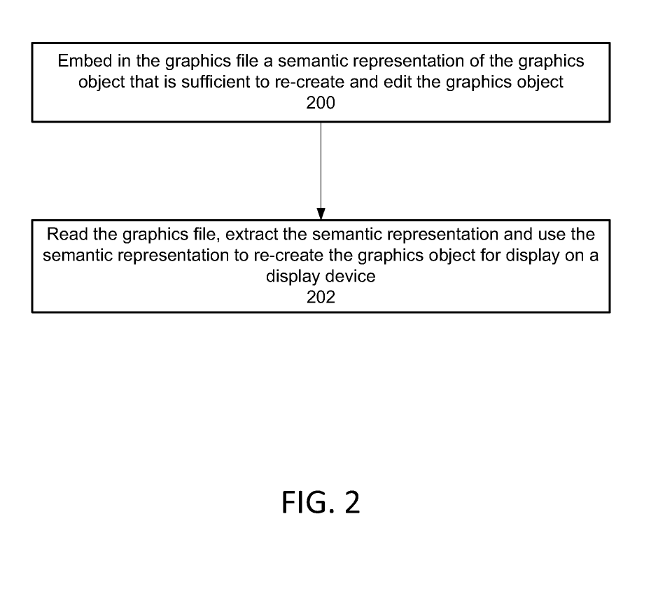

FIG. 2 is a flow diagram illustrating one embodiment of a process for preserving a graphics file. The process may begin by the editing tool 114 embedding in the graphics file 118 a semantic representation 122 of the at least one graphics object that is sufficient to re-create and edit the graphics object (block 200). A second application such as editing tool 114′, reads the graphics file 118, extracts the semantic representation 122 and uses the semantic representation 122 to re-create the graphics object 116 for display on a display device 106′ (block 202).

The steps of embedding the graphics file 118 with the semantic representation 122 and then extracting semantic representation 122 according to the exemplary embodiment, allows a user to use the graphical file 118 with any editing tool that supports the format of the graphics file 118. Example types of editing tool 114′ may include word processing programs, presentation tools, web and document publishing tools, and the like. The editing tool 114′ may re-create, modify, and/or verify the visual representation of the graphics object 118.

Referring again to the example described above where a new web designer needs to modify existing charts in a web report, with the exemplary embodiment, the new web designer would simply read the graphics file 118 into her editing tool 114′. As per block 202 in FIG. 2, the editing tool 114′ would read the embedded semantic representation 122 and re-create the charts in a form suitable for editing.

In one embodiment, the semantic representation 122 may be embedded into the exported graphics file 118 as a custom comment, with the result that the editing tool 114′ can identify the semantic representation 122, while the other general-purpose tools may ignore the semantic representation 122. Graphic file formats that can be used for this purpose may include virtually all vector formats (Postscript and variants including PDF and EPS; Scalable Vector Graphics (SVG); Windows EMF files; Dojo scene trees; and Microsoft VML). Some non-vector (raster) formats such as PNG also support comments.

Further details of the process for embedding the semantic representation 122 into the graphics file 118 will now be described. The editing tool 114 first translates a visual specification of the graphics object 116 to text-based semantic representation. In one embodiment, the text-based semantic representation may be created using a language-based specification or other semantic language. The editing tool 114 creates and/or saves a standard format graphics file with the text-based semantic representation embedded as a comment or other metadata. The editing tool 114 then exports or otherwise makes the standard format graphics 118 file available for use in another system.

In the other system, another application that needs to, for example, create an editable version of the graphics object 116 reads the standard format graphics file, and checks for an embedded comment comprising the text-based semantic representation. If the text-based semantic representation is present, the application reverse translates the text-based semantic representation back into a visual specification of the graphics object 116, and uses the visual specification to re-create the graphics object 116.

In one embodiment, the semantic representation may be implemented as a semantic language to define a chart. In one embodiment, the semantic language of a graphical object, such as a chart, defines the chart in terms of features, not types. For example, a bar chart may be defined using 2-D coordinates, categorical X numerics displayed with intervals job from locations: A line chart may be defined using 2-D coordinates, with X numerics displayed with lines connecting locations: and a histogram may be defined using 2-D coordinates, with numeric X statistic binned counts displayed with intervals dropped from location. In one embodiment, a composable set of chart features may include, but are not limited to: and element type, layouts, faceting, guides, aesthetics, and coordinates.

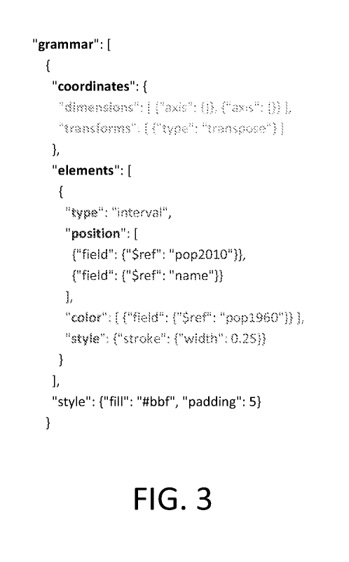

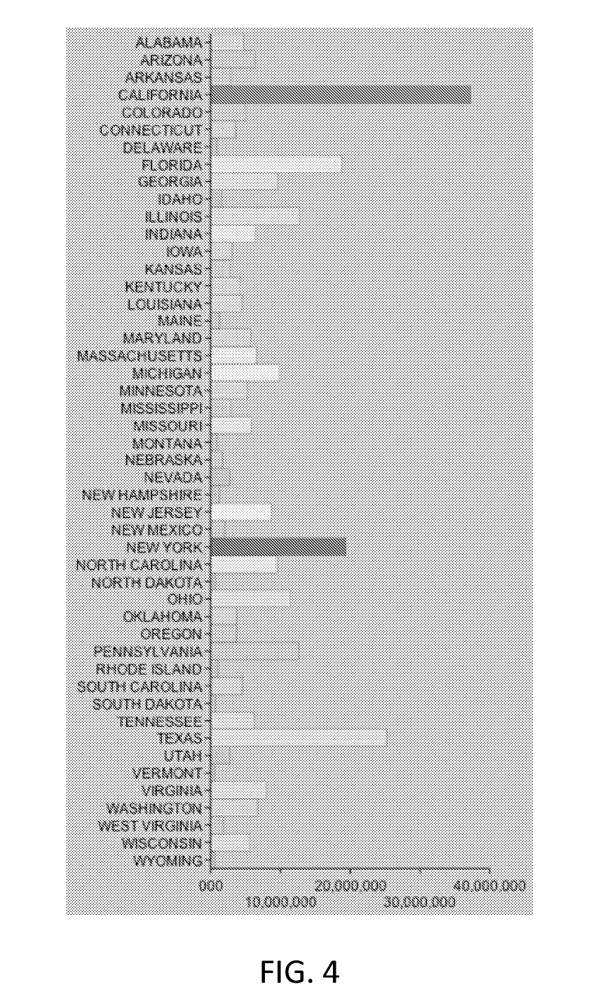

FIG. 3 is a diagram illustrating an example semantic language for a chart definition, and FIG. 4 is a diagram of the chart that is generated from the semantic language chart definition. In the example shown in FIG. 3, the grammar of the chart semantic language utilizes an “element” parameter of type “interval”, a “position” parameter showing state names by current population, a “color” parameter that uses population data from 1960, and a “style” parameter creating a thin border.

In a further aspect of the exemplary embodiment, the editing tool 114 may further include the ability to embed a checksum (such as a PGP checksum) as part of the translation step to provide authentication that neither the graphical object 116 or the embedded semantic representation 122 in the graphics file 118 have been altered since creation.

In a further aspect of the exemplary embodiment, the editing tool 114′ may include the ability to show differences between the re-created graphics object and the graphics object 116 embedded in the graphics file 118 to allow a user to manually check for any differences. In another embodiment, the editing tool 114′ may automatically compare the differences between the re-created graphics object and the graphics object 116 embedded in the graphics file 118 to automatically validate that the re-created graphics object is correct.

By way of example, assume that a user, Anastasia, is creating a chart to show the effects of a medical drug trial. She creates a clustered bar chart comparing before and after scores for two different treatments, built using a data set in standard tabular data format. She wishes to save the data into a report to be distributed as a PDF file, so she exports the bar chart in PDF format and embeds it in the report, using a second tool.

A second user, Badu, receives this report and is surprised at the results, which look different from his experiences. He wants to (i) validate that the PDF document has not been edited or maliciously altered, and (ii) recreate the chart in a more standard format so he can directly compare it to results from a comparable study. He cannot do so without contacting Anastasia directly, which may not be possible for many reasons.

With conventional editing tools, the PDF file has little information regarding how the bar chart was created. This disconnect between the bar chart in the PDF file and the creation process used to create the bar chart makes it a challenge to validate that the bar chart is authentic, to document how the bar chart was created, and/or to modify the creation process.

According to the exemplary embodiment, however, Badu would open the PDF with any compatible PDF tool configured as described herein, which would read in the PDF file; validate the checksums match to show the bar chart has not been altered, and then re-create the bar chart for editing and saving to a format he requires.

A method and system for preserving a graphics file has been disclosed. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for preserving a graphics file including at least one graphic object, comprising:
embedding in the graphics file, by a first application executing on a processor, a semantic representation of the at least one graphics object that is sufficient to re-create and edit the graphic object; and
reading the graphics file, by a second application, and extracting the semantic representation and using the semantic representation to re-create the graphics object for display on a display device.

2. The method of claim 1, wherein the embedding further comprises: embedding the semantic representation in the graphics file as a comment.

3. The method of claim 1, wherein the graphics file is saved in a format comprising one of a vector format and a raster format.

4. The method of claim 1, wherein the embedding further comprises:
translating a visual specification of the graphics object to text-based semantic representation; and
saving and exporting a standard format graphics file with the text-based semantic representation embedded as at least one of a comment and other metadata.

5. The method of claim 4, further comprising:
the second application reading the standard format graphics file and checking for the comment comprising the text-based semantic representation; and
responsive to the text-based semantic representation being present, reverse translating the text-based semantic representation back into a visual specification of the graphics object, and using the visual specification to re-create the graphics object.

6. The method of claim 4, wherein the text-based semantic representation is created using a language-based specification.

7. The method of claim 1, wherein the embedding further comprises: embedding a checksum in the graphics file along with the semantic representation to provide authentication but neither the graph object nor the semantic representation has been altered.

8. The method of claim 1, wherein reading the graphics file further comprises: the second application showing any differences between the re-created graphics object and the graphics object in the graphics file.

9. An executable software product stored on a computer-readable medium containing program instructions for preserving the graphics file, the program instructions for:
embedding in the graphics file, by a first application executing on a processor, a semantic representation of the at least one graphics object that is sufficient to re-create and edit the graphic object; and
reading the graphics file, by a second application, and extracting the semantic representation and using the semantic representation to re-create the graphics object for display on a display device.

10. The method of claim 9, wherein the embedding further comprises program instructions for: embedding the semantic representation in the graphics file as a comment.

11. The method of claim 9, wherein the graphics file is saved in a format comprising one of a vector format and a raster format.

12. The method of claim 9, wherein the embedding further comprises program instructions for:
translating a visual specification of the graphics object to text-based semantic representation; and
saving and exporting a standard format graphics file with the text-based semantic representation embedded as at least one of a comment and other metadata.

13. The method of claim 12, further comprising program instructions for:
the second application reading the standard format graphics file and checking for the comment comprising the text-based semantic representation; and
responsive to the text-based semantic representation being present, reverse translating the text-based semantic representation back into a visual specification of the graphics object, and using the visual specification to re-create the graphics object.

14. The method of claim 12, wherein the text-based semantic representation is created using a language-based specification.

15. The method of claim 9, wherein the embedding further comprises program instructions for: embedding a checksum in the graphics file along with the semantic representation to provide authentication but neither the graph object nor the semantic representation has been altered.

16. The method of claim 9, wherein reading the graphics file further comprises program instructions for: the second application showing any differences between the re-created graphics object and the graphics object in the graphics file.
